(19) United States
(12) Patent Application Publication
(10) Pub. No.: US 2025/0385031 A1
(43) Pub. Date: Dec. 18, 2025

(54) PRESSURE COMPENSATION SYSTEM WITH DOUBLE BARRIER

(71) Applicant: OneSubsea IP UK Limited, London (GB)

(72) Inventor: Audun Magne Askeland, Bergen (NO)

(21) Appl. No.: 18/741,438

(22) Filed: Jun. 12, 2024

Related U.S. Application Data
(60) Provisional application No. 63/507,640, filed on Jun. 12, 2023.

(51) Int. Cl. H01F 27/02; H01F 38/00

(52) U.S. Cl. CPC H01F 27/022; H01F 38/00

(57) ABSTRACT

A subsea system includes a tank configured to house a transformer surrounded by a first volume, and a compensation system coupled to the tank. The compensation system includes a housing disposed about a central axis, first and second flexible walls disposed about the central axis inside the housing, and a compensator cover coupled to the first and second flexible walls. The first flexible wall and the compensator cover defines a second volume with a first axial end of the housing. The housing and the first and second flexible walls define a third volume. The second flexible wall and the compensator cover define a fourth volume. The first and second volumes are configured to balance pressures relative to one another. The fourth volume is configured to balance pressures between a surrounding seawater and the second volume. The first and second flexible walls define a double barrier separated by the third volume.

### CROSS-REFERENCE TO RELATED APPLICATION

This application claims priority to and the benefit of U.S. Provisional Patent Application Ser. No. 63/507,640, entitled “Pressure Compensation System with Double Barrier,” filed Jun. 12, 2023, which is hereby incorporated by reference in its entirety for all purposes.

### BACKGROUND

The present disclosure relates to subsea power transformers. More particularly, the present disclosure relates to a pressure compensation system for subsea power transformers.

Subsea transformers are useful for powering off-shore equipment where power sources may not be readily available. For example, in offshore oil and gas fields, subsea transformers may enable the operation of equipment like pumps, compressors, and other machinery used for extraction and processing. These subsea facilities are often located many kilometers away from platforms or the shore, making subsea transformers essential for delivering usable power. Overall, subsea transformers are a vital technology for deep-sea operations, enabling efficient and cost-effective power delivery for various applications across the oil and gas, subsea processing, and renewable energy sectors. The same methodology can also be applied with remote power generation brought back to shore, for instance offshore wind farms, where a subsea transformer in a subsea substation can increase transmission voltage from the wind turbines.

Traditional subsea transformers typically use bellows of thin-walled stainless steel for volumetric changes in the fluid. The fabrication is complicated, and quality assurance is difficult. When the size of the transformer increases, a much larger number of these bellows (e.g., greater than six) is needed, which increases cost, complexity, and risk. Subsea transformers comprise a major component of a subsea substation and must be hermetically sealed against the seawater, but also pressure compensated. Further, pressure changes may cause movement of the bellows, making the thin-walled steel potential sources of failure. Therefore, to increase reliability, a need exists for a subsea transformer system having a pressure/volumetric compensation system with a double dynamic barrier.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a subsea system includes a tank configured to house a transformer surrounded by a first volume of a first fluid, and a compensation system coupled to the tank. The compensation system includes a housing disposed about a central axis, first and second flexible walls disposed about the central axis inside of the housing, and a compensator cover coupled to the first and second flexible walls at an axial position between first and second axial ends of the housing. The first flexible wall and the compensator cover defines a second volume between the compensator cover and the first axial end. The housing and the first and second flexible walls define a third volume. The second flexible wall and the compensator cover define a fourth volume. The first and second volumes are configured to balance pressures relative to one another. The fourth volume is configured to balance pressures between a surrounding seawater and the second volume. The first and second flexible walls define a double dynamic barrier separated by the third volume.

In certain embodiments, a subsea system includes a tank configured to house a component surrounded by a first volume of a first fluid, and a compensation system coupled to the tank. The compensation system includes a housing disposed about a central axis, first and second bellows disposed about the central axis inside of the housing, and a compensator cover coupled to the first and second bellows at an axial position between first and second axial ends of the housing. The first bellows and the compensator cover defines a second volume between the compensator cover and the first axial end. The housing and the first and second bellows define a third volume. The second bellows and the compensator cover define a fourth volume. The first and second volumes are configured to balance pressures relative to one another. The fourth volume is configured to balance pressures between a surrounding seawater and the second volume. The first and second bellows define a double dynamic barrier separated by the third volume.

In certain embodiments, a method includes housing a transformer surrounded by a first volume of a first fluid in a tank, and pressure balancing the tank with a compensation system coupled to the tank. The compensation system includes a housing disposed about a central axis, first and second flexible walls disposed about the central axis inside of the housing, and a compensator cover coupled to the first and second flexible walls at an axial position between first and second axial ends of the housing. The first flexible wall and the compensator cover defines a second volume between the compensator cover and the first axial end. The housing and the first and second flexible walls define a third volume. The second flexible wall and the compensator cover define a fourth volume. The pressure balancing includes balancing pressures between the first and second volumes, balancing pressures between a surrounding seawater and the second volume via the fourth volume, and defining a double dynamic barrier separated by the third volume via the first and second flexible walls.

### BRIEF DESCRIPTION OF THE DRAWINGS

The subject disclosure is further described in the following detailed description, and the accompanying drawings and schematics of non-limiting embodiments of the subject disclosure. The features depicted in the figures are not necessarily shown to scale. Certain features of the embodiments may be shown exaggerated in scale or in somewhat schematic form, and some details of elements may not be shown in the interest of clarity and conciseness. These and other features, aspects, and advantages of the present invention will become better understood when the following detailed description is read with reference to the accompanying drawings in which like characters represent like parts throughout the drawings, wherein:

FIG. 1 is a diagram illustrating a subsea system having a subsea transformer disposed in a subsea transformer tank with a pressure compensation system, according to some embodiments;

FIG. 2 is a schematic of a subsea transformer tank having a pressure compensation system with a double barrier having bellows, wherein the bellows directly couples to the subsea transformer tank according to certain embodiments;

FIG. 3 is a schematic of a subsea transformer tank having a pressure compensation system with a double barrier having bellows, wherein the bellows couples to the subsea transformer tank via piping or tubing according to certain embodiments;

FIG. 4 is a schematic of a subsea transformer tank having a pressure compensation system with a double barrier having bellows, wherein the bellows couples to the subsea transformer tank via piping or tubing according to certain embodiments;

FIG. 5 is a schematic of a subsea transformer tank having a pressure compensation system with a double barrier having bellows, wherein the bellows couples to the subsea transformer tank via piping or tubing in a horizontal orientation according to certain embodiments;

FIG. 6 is a schematic of a subsea transformer tank having a pressure compensation system with a double barrier having bellows, wherein the bellows couples to the subsea transformer tank via piping or tubing in an inverted orientation according to certain embodiments;

FIG. 7 is a schematic of a subsea transformer tank having a pressure compensation system with a double barrier having bellows, wherein the bellows couples to the subsea transformer tank via piping or tubing, and the bellows is disposed in a housing having a cover with piping to a surrounding environment according to certain embodiments; and

FIG. 8 is a schematic of a subsea transformer tank having a pressure compensation system with a double barrier having bellows, wherein the bellows couples to the subsea transformer tank via piping or tubing according to certain embodiments described herein.

### DETAILED DESCRIPTION

One or more specific embodiments of the present disclosure will be described below. The particulars shown herein are by way of example, and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are used in an open-ended fashion, and thus should be interpreted to mean “including, but not limited to.” Also, any use of any form of the terms “connect,” “engage,” “couple,” “attach,” or any other term describing an interaction between elements is intended to mean either an indirect or a direct interaction between the elements described. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience but does not require any particular orientation of the components.

Certain terms are used throughout the description and claims to refer to particular features or components. As one skilled in the art will appreciate, different persons may refer to the same feature or component by different names. This document does not intend to distinguish between components or features that differ in name, but not function.

The present disclosure relates to an embodiment of a transformer or heat generating device disposed within a tank (e.g., transformer tank) with a compensation system having a double dynamic barrier formed by one or more bellows. For example, as discussed in detail below, the tank may be filled with a fluid (e.g., a dielectric fluid such as an insulating oil), wherein the fluid expands in response to heat generated by the transformer or heat generating device. The compensation system enables expansion of the fluid while also forming a double barrier between the fluid and a surrounding environment, such as seawater in a subsea deployment. The double barrier includes a first bellows portion between the seawater and an intermediate fluid (e.g., dielectric fluid such as insulating oil) and a second bellows portion between the intermediate fluid and the fluid within the tank. Thus, for seawater to leak into the tank, the potential leak would need to first leak through the first bellows portion into the intermediate fluid and then subsequently leak through the second bellows portion into the fluid in the tank. In this manner, the first bellows portion creates a first barrier and the second bellows portion creates a second barrier. In some embodiments, the intermediate fluid may include a further pressure compensation using a bellows. However, the double barrier formed by the first and second bellows portion may be used with or without the further pressure compensation. Various aspects of the compensation system are discussed in further detail below. Although the compensation system may be used with a transformer in a subsea environment, the compensation system may be used with any subsea equipment disposed in a tank, such as subsea electronics and power equipment, subsea batteries, subsea controllers or control systems, subsea actuators, or any combination thereof.

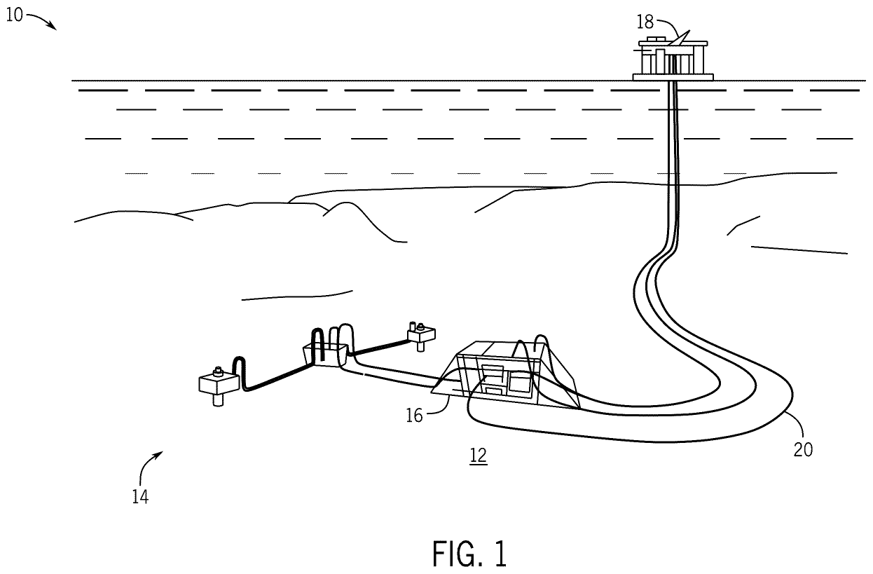

FIG. 1 is a diagram illustrating a subsea system 10 having a subsea transformer 16, according to some embodiments. For example, a station 14 (e.g., floating substation) may be located on the sea floor 12, which may be downstream of several wellheads and/or trees of an off-shore oil rig 18 being used, for example, to produce hydrocarbon-bearing fluid from a subterranean rock formation. The station 14 may include a subsea transformer 16. The station 14 may be connected to one or more umbilical or power cables 20. The cables 20 may be run from the oil rig 18, for example, through the seawater along sea floor 12 and to the station 14. In other cases, the cables 20 may be run from some other off-shore or surface facility such as a floating production, storage and offloading unit (FPSO), or a shore-based facility. In addition to the transformer 16, the station 14 may also include various other types of subsea equipment, including one or more pumps, compressors, electric motors or actuators, electric generators, manifolds, valves, power distribution equipment, controllers or control systems, monitoring systems, or any combination thereof. The cables 20 may be used to supply barrier and other fluids, and control and data lines for use with the subsea equipment in the station 14. The station 14 may include one or more tanks having compensations systems, such as described in further detail below, to separately or collectively house the foregoing components of the station 14. Accordingly, although the following discussion refers to compensation systems for transformer tanks, the embodiments discussed below are applicable to a variety of subsea equipment disposed in tanks.

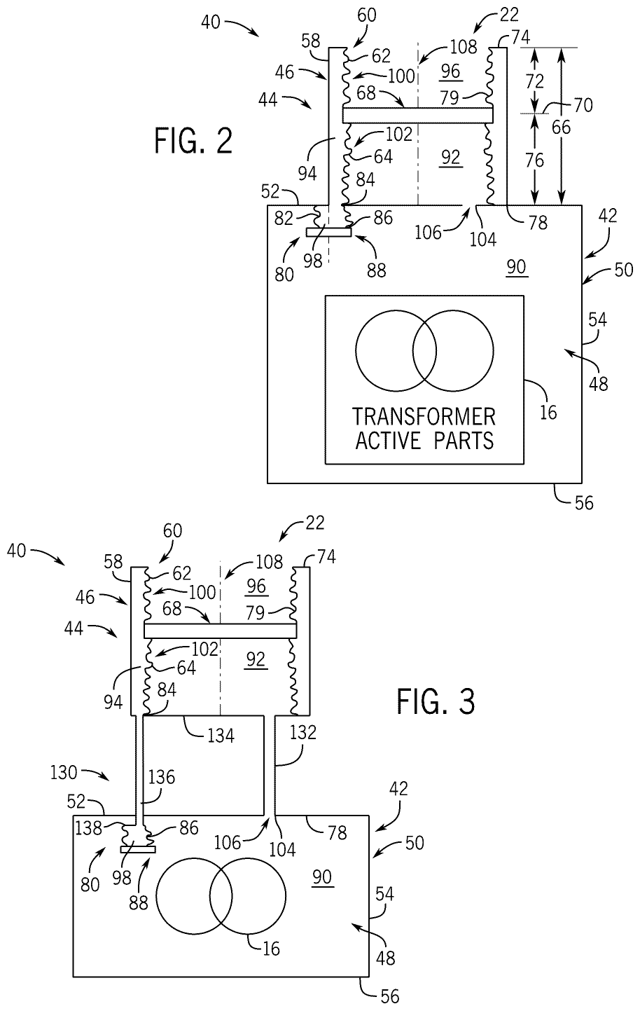

Although not depicted in FIG. 1, it should be noted that the subsea system 10 having the subsea transformer 16 may be part of a station 14 that is downstream of an offshore wind farm. For example, the station 14 may be connected to one or more umbilical or power cables 20 that may be run from an offshore wind farm, for example, through the seawater along sea floor 12 and to the station 14. In such embodiments, the offshore wind farm may include one or more wind turbines that may be connected to floating substation or a subsea station similar to the station 14 shown in FIG. 1. FIG. 2 illustrates a schematic diagram of a subsea assembly 40 the transformer 16 disposed in a tank 42 (e.g., subsea transformer tank) having a compensation system 44, wherein the compensation system 44 is a pressure and volume compensation system with a double dynamic barrier 46 for the pressure and volume compensation of a dielectric fluid 48 (e.g., insulating liquid such as oil) in the tank 42 according to certain embodiments. The tank 42 may house the active transformer parts and other associated components of the transformer 16, thereby protecting the transformer 16 from a surrounding subsea environment (e.g., seawater 22). Although the tank 42 may be used to house the transformer 16, the tank 42 may be used to house any subsea equipment (e.g., heat generating equipment), such as one or more pumps, compressors, electric motors or actuators, electric generators, manifolds, valves, power distribution equipment, controllers or control systems, monitoring systems, or any combination thereof. Additionally, the tank 42 contains the dielectric fluid 48 to provide insulation and cooling of the transformer 16. For example, the transformer 16 may generate heat during operation, thereby causing changes in temperature and pressure of the dielectric fluid 48 inside the tank 42. As the tank 42 transformer heats up, the dielectric fluid 48 may provide insulation and cooling to prevent overheating of the parts and components within the tank 42. As a result, the dielectric fluid 48 may experience pressure and volume changes inside the tank 42, while the tank 42 is surrounded by seawater 22 at an elevated pressure depending on the depth in the seawater 22. Accordingly, the temperature and pressure may vary both inside and outside of the tank 42.

In the illustrated embodiment, the tank 42 includes a pressure vessel or enclosure defined by an outer wall 50, which includes a top wall 52, a side wall 54 (or multiple side walls), and a bottom wall 56. The outer wall 50 (e.g., walls 52, 54, and 56) may define a cylindrical enclosure, a rectangular enclosure, or any combination thereof. The outer wall 50 may include a metal outer wall, such as a steel outer wall. The transformer 16 is contained within the tank 42 and is immersed within the dielectric fluid 48.

The compensation system 44 includes a housing 58 surrounding and supporting a bellows 60, which includes adjacent bellows or bellows portions 62 and 64. In certain embodiments, the housing 58 includes a cylindrical or annular housing, such as an annular sleeve (e.g., annular outer wall) disposed about the bellows 60. The housing 58 may include a metal housing, such as a stainless steel housing. Similarly, the bellows 60 may include a metal bellows, such as a stainless steel bellows. The housing 58 and the bellows 60 may be concentric or coaxial with one another, such that the housing 58 circumferentially sounds the bellows 60 along an axial length 66 of the bellows 60. In the illustrated embodiment, the bellows 60 includes a compensator top cover 68 (e.g., metal or stainless steel cover) at an axial position 70 between the bellows 62 and 64, wherein the bellows 62 extends an axial distance 72 from an end portion 74 of the housing 68 to the axial position 70 and the bellows 64 extends an axial distance 76 from an end portion 78 of the housing 68 to the axial position 70. Thus, in the illustrated embodiment, the compensator top cover 68 is disposed at the axial position 70 offset from the end portions 74 and 78 of the housing 58. The bellows 60 may be a single continuous bellows forming the bellows 62 and 64, or the bellows 60 may include two separate bellows 62 and 64 coupled to the compensator top cover 68. The compensator top cover 68 may be a flat circular plate (e.g., disc or piston), which is fixed to an inner annular surface 79 of the bellows 60. For example, the compensator top cover 68 may be welded to the bellows 60 along the inner annular surface 79, or the compensator top cover 68 and the bellows 60 may be formed as a continuous one-piece structure. In the illustrated embodiment, the housing 58 is directly coupled to the outer wall 50 of the tank 42, specifically at the top wall 52 of the tank 42. In some embodiments, the housing 58 is directly coupled to the outer wall 50 or indirectly coupled to the outer wall 50 (e.g., via piping or tubing) as discussed in further detail below.

In certain embodiments, the compensation system 44 may include a supplemental compensator 80 having a bellows 82. For example, the bellows 82 may include a metal bellows, such as a stainless-steel bellows. In the illustrated embodiment, the bellows 82 is disposed inside of the tank 42. However, in certain embodiments, the bellows 82 may be disposed inside or outside of the tank 42, directly coupled to the tank 42, or indirectly coupled (e.g., via piping) to the tank 42 as discussed in further detail below. In the illustrated embodiment, the bellows 82 is directly coupled to the tank 42 at the top wall 52 of the outer wall 50. In particular, an end portion 84 of the bellows 82 is coupled to the top wall 52 adjacent the bellows 60, while an end portion 86 of the bellows 82 is coupled to a compensator cover 88 (e.g., metal or stainless-steel cover). The compensator cover 88 may be a flat circular plate (e.g., disc or piston), which is fixed to the end portion 86 of the bellows 82. For example, the compensator cover 88 may be welded to the bellows 82 at the end portion 86, or the compensator cover 88 and the bellows 82 may be formed as a continuous one-piece structure. In the illustrated embodiment, the bellows 60 and 88 are directly adjacent one another and separated only by the top wall 52. However, as noted above, the bellows 60 and 88 may be separated from one another and fluidly coupled together via piping in some embodiments.

In the illustrated embodiment, operation of the compensation system 44 may be described with reference to a first volume 90 (e.g., main fluid chamber) in the tank 42, a second volume 92 (e.g., expansion fluid chamber) inside of the bellows 64 axially between the compensator top cover 68 and the top wall 52 of the tank 42, a third volume 94 (e.g., main bellows chamber, annular chamber) disposed between the housing 58 and the bellows 60, a fourth volume 96 (e.g., external chamber) disposed inside of the bellows 62 above the compensator top cover 68 in fluid communication with seawater 22, and a fifth volume 98 (e.g., secondary bellows chamber, annular chamber) disposed inside of the bellows 82. In the illustrated embodiment, the various volumes 90, 92, 94, 96, and 98 enable pressure balancing and volumetric changes to accommodate changes in temperature and pressure in the tank 42 and the seawater 22. Additionally, the third volume 94 acts as a buffer chamber between a first barrier 100 defined by the bellows 62 and a second barrier 102 defined by the bellows 64, thereby creating the double dynamic barrier 46 of the compensation system 44. Various aspects of the compensation system 44 are discussed in further detail below.

In the illustrated embodiment, the tank 42 includes the compensation system 44 for pressure and volume compensation. For example, the compensation system 44 may balance the internal pressure of the tank 42 with external pressure from the seawater 22. Pressure changes may bring about temperature changes, or vice versa. As the temperature of the tank 42 fluctuates, the compensation system 44 may also accommodate the changes in temperature and pressure by allowing or enabling volume expansion and contraction. For example, flexible, accordion-like structures, such as bellows 60 and 82, may expand and contract to balance internal and external pressures to accommodate changes in temperature and volume of the dielectric fluid 48. As mentioned above, the flexible thin-walled portion of the bellows 60 and 82 may increase risk of leaks where seawater may seep into the bellows and, ultimately, the tank 42, thereby potentially causing failure of the subsea transformer 16.

Continuing with FIG. 2, the tank 42 may have the compensation system 44 with one or more metal bellows 60 providing the double barrier 46 for the pressure and volume compensation of the dielectric fluid 48 in the tank 42 surrounding the transformer 16. The double dynamic barrier 46 may provide an additional “layer” of protection to prevent the penetration of seawater into the tank 42. For example, in the compensation system 44, the first volume 90 (e.g., main fluid chamber) of the tank 42 may be in communication with the second volume 92 (e.g., expansion fluid chamber) of the bellows 60 through a flow path 104. The flow path 104 may be an opening or passage through the tank 42 between the first and second volumes 90 and 92. In certain embodiments, the first and second volumes 90 and 92 are isolated or separated from one another by a moveable barrier 106, such as a flexible bladder or membrane, a piston, or a combination thereof. For example, the flexible bladder or membrane may be an elastomeric wall disposed at the flow path 104, which may be enlarged to enable a greater flexibility to allow movement between the first and second volumes 1 and 2. However, in the illustrated embodiment, the dielectric fluid 48 freely flows through the flow path 104 between the first and second volumes 90 and 92 without the moveable barrier 106. When the dielectric fluid 48 in the first volume 90 expands in response to heat generated by the transformer 16, the dielectric fluid 48 may flow through the flow path 104 into the second volume 92 of the bellows 60 (e.g., within bellows 64). In doing so, the dielectric fluid 48 may move the compensator top cover 68 in an axial or vertical direction along axis 108, thereby expanding the second volume 92 and a total volume of the combined first and second volumes 90 and 92. The resulting change of the second volume 92 compensates for the volumetric expansion of the dielectric fluid 48. Further, pressure may be prevented from building up in the first volume 90 and/or the second volume 92.

Meanwhile, the third volume 96 may be in a portion of the bellows 60 that is exposed to the seawater 22. As such, the third volume 96 may be in communication with the surrounding seawater 22. An increase in pressure of the seawater 22 during installation in deep water locations may move the compensator top cover 68 downwards along the axis 108 to compensate for volumetric compression of the dielectric fluid 48 in the first and second volumes 90 and 92 to prevent the tank 42 from collapsing.

Additionally, in the illustrated embodiment, the bellows 60 is enclosed by the housing 58 to create the fourth volume 94. The fourth volume 94 may be an annular fluid chamber (e.g., primary bellows chamber) defined by an annular shape of the housing 58 and an annular shape of the bellows 60. This fourth volume 94 may provide a buffer volume to enable the double barrier 46 in that the fourth volume 94 may be divided into two portions (e.g. an upper and a lower portion) of the bellow 24, particularly the bellows 62 and the bellows 74. The bellows 60 may comprise the same or different materials and diameters in the bellows 62 and 64. The upper and lower bellows 62, 64 may form two independent dynamic sealing elements that are connected to the same moving plate (i.e., compensator top cover 68). In this way, the metallic barriers or bellows 62 and 64 may operate similarly to bellows in a series. That is, between the seawater 22 (third volume 96) and the first volume 90, the thin-walled, accordion barriers may be vulnerable to leaks due to cyclic strain. This cyclic strain may be present in bellows 62 and 64. If an upper portion or the first bellow 62 leaks, the seawater 22 will only enter the fourth volume 94 and not the first volume 90 or the second volume 92. If a lower portion or the second bellows 64 leaks, the fourth volume 94 will exchange fluid with the first volume 90 and the second volume 92. This exchange may not be detrimental as the fluid in the fourth and first volumes 94 and 90 have the same or similar properties, as described in more detail below.

In certain embodiments, the fourth volume 94 may communicate with the fifth volume 98, which may be provided by the bellows 82. The communication between volume 94 and volume 98 may compensate for volume changes in the fourth volume 94 by moving the compensator cover 88 in an axial or vertical direction along axis 110. For example, when fluid (e.g. dielectric fluid 48 or seawater 22) in fourth volume 94 expands, the fluid may flow into the fifth volume 98. In doing so, the fluid may move the compensator cover 88 in an axial or vertical direction along axis 110. The resulting change of the fifth volume 98 compensates for the volumetric expansion of the fluid. Further, pressure may be prevented from building up in the first volume 90 and/or the second volume 92.

In an embodiment, the first, second, fourth, and fifth volumes may contain a dielectric fluid, such as an insulating liquid (e.g., oil). In other embodiments, the first, second, fourth, and fifth volumes may contain any other suitable fluid for separating the first volume 90 from seawater 22 and the third volume 96 including, but not limited to, dielectric fluids, Midel 7131, and Nynas Nytro 10X. An intermediate chamber (e.g., the second volume 92) may have a different fluid than an inner main chamber (e.g., the first volume 90); for example, the intermediate chamber may have a more environmentally friendly fluid than the fluid of the inner main chamber, but with generally similar properties as the fluid in the inner chamber. In particular, Midel 7131 may be disposed in the intermediate chamber and Nynas Nytro 10X may be disposed in the inner main chamber.

Although the embodiment shown in FIG. 1 illustrates the compensation system 44 integrated on the main tank 42, there may be numerous other embodiments where the compensation system 44 may be disposed differently, as illustrated in FIGS. 3-8. For example, in FIG. 3, the compensation system 44 may be disposed at a distance away from the tank 42 and coupled to the tank 42 via piping 130 (e.g., one or more fluid conduits or tubing). In such an embodiment, the flow path 104 may comprise piping 132 (e.g., fluid conduit or tubing) as shown in FIG. 3. In the embodiment of FIG. 3, a chamber housing the second volume 92 may further comprise an enclosing lid or bottom lid (e.g., bottom wall 134) coupled to the end portion 78 of the housing 58 and the bellows 64. Additionally, the secondary bellows 82 may be disposed at a distance away from the compensation system 44 (e.g. bellows 62 and 64), but the secondary bellows 82 may be connected to the compensation system 44 via piping 136 (e.g., fluid conduit or tubing). As further illustrated in FIG. 3, the supplemental compensator 80 having the bellows 80 is offset from the top wall 52 inside of the tank 42, wherein the bellows 80 further includes an end cover portion 138 coupled to the end portion 84 of the bellows 80 opposite from the compensator cover 88. In turn, the end cover portion 138 is coupled to the piping 136, which extends through the top wall 52 of the tank 42 and extends to the bottom wall 134 into the fourth volume 94. Otherwise, the subsea assembly 40 of FIG. 3 is substantially the same as discussed above with reference to FIG. 2. Thus, like numbers are used to depict like elements.

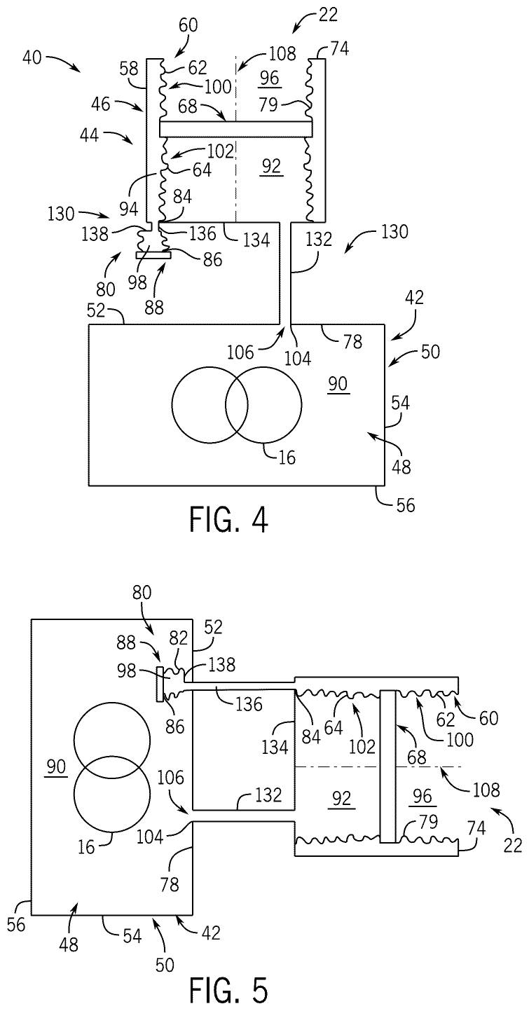

Alternatively, in another embodiment, the compensation system 44, including the bellows 62 and 64 and the secondary bellows 82 may both be disposed at a distance away from the tank 42, as shown in FIG. 4. That is, FIG. 4 provides a schematic of the tank 42 (e.g., subsea transformer tank) connected to compensation bellows 62 and 64 and 26 via piping 130, where the compensation system 44 is located at a distance away from the tank 42. In such an embodiment, the second volume 92 (housed in a chamber) may remain in fluid connection with the tank 42 of the transformer 16 via the piping 132, while the secondary bellows 82 of the supplemental compensator 80 may be in fluid communication with the seawater 22. In other words, the secondary bellows 82 of the supplemental compensator 80 may be moved outside of the first volume 90 of the tank 42, such that an exterior of the secondary bellows 82 is surround by the seawater 22 rather than the dielectric fluid 48 in the tank 42. Otherwise, the subsea assembly 40 of FIG. 4 is substantially the same as discussed above with reference to FIGS. 2 and 3. Thus, like numbers are used to depict like elements.

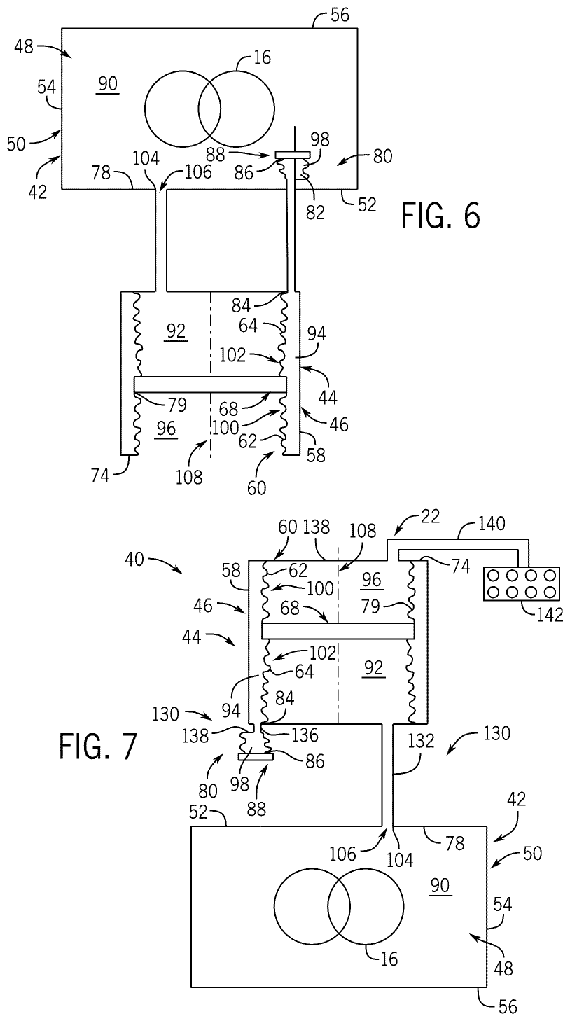

While the embodiments illustrated in FIGS. 2-4 show the tank 42 and compensation system 44 in a vertical orientation, in other embodiments, the systems may be configured in other orientations. For example, the subsea assembly 40 of FIGS. 2-4 may be rotated to any desired orientation, such that the equipment is the same, but the components are rearranged in any suitable vertical orientation, horizontal orientation, angled orientation, inverted orientation, or any combination thereof. For example, turning now to FIG. 5, FIG. 5 illustrates a schematic of the tank 42 (e.g., subsea transformer tank) in an embodiment where the tank 42 and piping 130 may be configured in a horizontal orientation. In another embodiment, as shown in FIG. 6, the subsea transformer tank 42 and piping 130 may be configured in an inverted orientation. However, the subsea assembly 40 of FIGS. 5 and 6 are substantially the same as discussed above with reference to FIGS. 2-4. Thus, like numbers are used to depict like elements.

Referring now to FIG. 7, a schematic of the tank 42 (e.g., subsea transformer tank) and piping 130 with a cover lid 138 and piping 130 at an upper end is shown. The cover lid 138 may be disposed on a chamber housing the third volume 96 and generally blocks or prevents particles from entering the third volume 96. For example, the cover lid 138 may be removably coupled (e.g., threaded or coupled with threaded fasteners) or fixedly coupled (e.g., welded joint) to the end portion 74 of the housing 58 and the bellows 62, thereby enclosing the third volume 96 inside the bellows 62 axially between the cover lid 138 and the compensator top cover 68. However, the third volume 96 is still fluidly coupled with the seawater 22 to enable pressure balancing between the seawater 22 and the internal fluids (e.g., dielectric fluid) within the compensation system 44 and the tank 42. For example, in the illustrated embodiment, a fluid conduit 140 (e.g., a piping, tubing, or hose) may be connected to the cover lid 138, thereby enabling fluid communication between the chamber housing the third volume 96 and the seawater 22. The deployment of the cover lid 138 on the chamber housing the third volume 96 may be applied in other embodiments of the disclosure. In some embodiments, the fluid conduit 140 may include an intake filter assembly 142 having a perforated body with one or more internal filters. However, the subsea assembly 40 of FIG. 7 is substantially the same as discussed above with reference to FIGS. 2-6. Thus, like numbers are used to depict like elements.

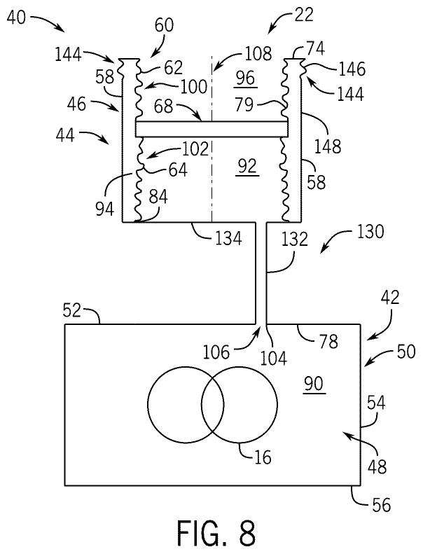

Referring now to FIG. 8, a schematic of the tank 42 (e.g., subsea transformer tank) connected to compensation bellows 60 (e.g., bellows 62 and 64) via piping 130 is shown. In this embodiment, the secondary bellows 82 may be replaced by extending an outer cylinder (e.g., outer cylindrical wall of the housing 58) of the compensation system 44 with a flexible portion 144. The replacement of the secondary bellows 82 with the flexible portion 144 may be applied in other embodiments of the disclosure, such as shown in FIGS. 2-7. In certain embodiments, the secondary bellows 82 and the flexible portion 144 may be used alone or in combination with one another in any of the embodiments of FIGS. 2-8. The illustrated flexible portion 144 may include a bellows portion 146 in at least a portion of an outer wall (e.g., outer cylindrical wall 148) of the housing 58. The flexible portion 144 (e.g., bellows portion 146) may be fixed coupled and/or integrally formed with the housing 58, and the flexible portion 144 may be a metal flexible portion (e.g., stainless steel). Otherwise, the subsea assembly 40 of FIG. 8 is substantially the same as discussed above with reference to FIGS. 2-7. Thus, like numbers are used to depict like elements.

The technical effect of the disclosed embodiments includes a compensation system 44 that provides a double barrier 46 via bellows 60 (e.g., bellows 62 and 64) and an intermediate buffer chamber (e.g., third volume 94) between the seawater 22 and the first and second volumes 90 and 92. As a result, even if one of the bellows 62 or 64 leaks, the intermediate buffer chamber (e.g., third volume 94) contains any leaked fluids to block contamination of the first and second volumes 90 and 92. Additionally, the supplemental compensator 80 having the bellows 82 and/or the flexible portion 144 may provide additional pressure compensation and/or volume compensation for the intermediate buffer chamber (e.g., third volume 94) by balancing pressures between the third volume 94 and the first volume 90 and/or between the third volume and the seawater 22. The compensation system 44 advantageously provides the pressure compensation with the double barrier 46 in a compact configuration, at least partially by using the compensator top cover 68 midway along the bellows 60 (e.g., between the bellows 62 and 64) and by using the intermediate buffer chamber (e.g., third volume 94) concentrically about the bellows 60.

The subject matter described in detail above may be defined by one or more clauses, as set forth below.

A subsea transformer pressure compensation system is described that includes: a transformer having a tank, and a compensation system. The compensation system comprises a first volume in communication with a second volume via a flow path and a third volume in communication with a fluid.

The subsea transformer of the preceding clause, the compensation system further having a compensator top cover, which is configured to move when expansion of a fluid in the first volume moves the fluid into the second volume.

The subsea transformer of any preceding clause, the compensation system further having a fourth volume in communication with a fifth volume.

The subsea transformer of any preceding clause, the compensation system further having a small compensator cover, which is configured to move when a fluid in the fourth volume expands.

The subsea transformer of any preceding clause, the compensation system further having a first bellows in series with a second bellows.

The subsea transformer of any preceding clause, the first and second bellows are disposed between the seawater and the first volume.

The subsea transformer of any preceding clause, the first and second bellows form two independent dynamic sealing elements that are connected to the compensator top cover.

The subsea transformer of any preceding clause, wherein the fluid is seawater.

The subsea transformer of any preceding clause, the flow path including a pipe or tubing and the compensation system is disposed a distance away from the tank.

The subsea transformer of any preceding clause, the compensation system further including a chamber having an enclosing lid.

A subsea system includes a tank configured to house a transformer surrounded by a first volume of a first fluid, and a compensation system coupled to the tank. The compensation system includes a housing disposed about a central axis, first and second flexible walls disposed about the central axis inside of the housing, and a compensator cover coupled to the first and second flexible walls at an axial position between first and second axial ends of the housing. The first flexible wall and the compensator cover defines a second volume between the compensator cover and the first axial end. The housing and the first and second flexible walls define a third volume. The second flexible wall and the compensator cover define a fourth volume. The first and second volumes are configured to balance pressures relative to one another. The fourth volume is configured to balance pressures between a surrounding seawater and the second volume. The first and second flexible walls define a double barrier separated by the third volume.

The system of the preceding clause, comprising the transformer disposed in the tank.

The system of any preceding clause, wherein the first flexible wall includes a first bellows and the second flexible wall includes a second bellows.

The system of any preceding clause, wherein the housing, the first and second bellows, and the third volume are annular and concentric with the central axis.

The system of any preceding clause, wherein first and second volumes are fluidly coupled together via an opening in the tank, a fluid conduit, or a combination thereof.

The system of any preceding clause, wherein the housing of the compensation system is directly coupled to the tank.

The system of any preceding clause, wherein the housing of the compensation system is offset away from the tank, wherein the first and second volumes are fluidly coupled with a fluid conduit.

The system of any preceding clause, wherein the compensation system includes a bottom wall coupled to the housing over the second volume, wherein the fluid conduit extends between the bottom wall and an outer wall of the tank.

The system of any preceding clause, wherein the compensation system includes a cover lid coupled to the housing over the fourth volume, wherein an opening or a fluid conduit is coupled to the cover lid and provides fluid communication with the surrounding seawater.

The system of any preceding clause, wherein an outer wall of the housing includes a flexible portion configured to enable expansion or contraction of the third volume.

The system of any preceding clause, wherein the third volume is fluidly coupled to a fifth volume of a supplemental compensator.

The system of any preceding clause, wherein the supplemental compensator includes a third bellows.

The system of any preceding clause, wherein the supplemental compensator is disposed inside of the tank.

The system of any preceding clause, wherein the supplemental compensator is disposed outside of the tank.

A subsea system includes a tank configured to house a component surrounded by a first volume of a first fluid, and a compensation system coupled to the tank. The compensation system includes a housing disposed about a central axis, first and second bellows disposed about the central axis inside of the housing, and a compensator cover coupled to the first and second bellows at an axial position between first and second axial ends of the housing. The first bellows and the compensator cover defines a second volume between the compensator cover and the first axial end. The housing and the first and second bellows define a third volume. The second bellows and the compensator cover define a fourth volume. The first and second volumes are configured to balance pressures relative to one another. The fourth volume is configured to balance pressures between a surrounding seawater and the second volume. The first and second bellows define a double barrier separated by the third volume.

The system of the preceding clause, wherein the housing of the compensation system is directly coupled to the tank.

The system of any preceding clause, wherein the housing of the compensation system is offset away from the tank, wherein the first and second volumes are fluidly coupled with a fluid conduit.

A method includes housing a transformer surrounded by a first volume of a first fluid in a tank, and pressure balancing the tank with a compensation system coupled to the tank. The compensation system includes a housing disposed about a central axis, first and second flexible walls disposed about the central axis inside of the housing, and a compensator cover coupled to the first and second flexible walls at an axial position between first and second axial ends of the housing. The first flexible wall and the compensator cover defines a second volume between the compensator cover and the first axial end. The housing and the first and second flexible walls define a third volume. The second flexible wall and the compensator cover define a fourth volume. The pressure balancing includes balancing pressures between the first and second volumes, balancing pressures between a surrounding seawater and the second volume via the fourth volume, and defining a double barrier separated by the third volume via the first and second flexible walls.

The method of the preceding clause, comprising adjusting the third volume with an outer wall of the housing comprising a flexible portion configured to enable expansion or contraction of the third volume.

The method of any preceding clause, comprising adjusting the third volume with a supplemental compensator comprising a third bellows separate from the housing.

Language of degree used herein, such as terms “approximately,” “about,” generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 5 degrees, 3 degrees, 1 degree or 0.1 degree.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. § 112 (f). However, for any claims containing elements designated in any other manner, it is intended that such elements are not to be interpreted under 35 U.S.C. § 112 (f).

What is claimed is:

1. A subsea system, comprising:
a tank configured to house a transformer surrounded by a first volume of a first fluid; and
a compensation system coupled to the tank, wherein the compensation system comprises:
a housing disposed about a central axis; first and second flexible walls disposed about the central axis inside of the housing; and
a compensator cover coupled to the first and second flexible walls at an axial position between first and second axial ends of the housing, wherein the first flexible wall and the compensator cover defines a second volume between the compensator cover and the first axial end, the housing and the first and second flexible walls define a third volume, and the second flexible wall and the compensator cover define a fourth volume, wherein the first and second volumes are configured to balance pressures relative to one another, and wherein the fourth volume is configured to balance pressures between a surrounding seawater and the second volume, wherein the first and second flexible walls define a double barrier separated by the third volume.

2. The system of claim 1, comprising the transformer disposed in the tank.

3. The system of claim 1, wherein the first flexible wall comprises a first bellows and the second flexible wall comprises a second bellows.

4. The system of claim 1, wherein the housing, the first and second bellows, and the third volume are annular and concentric with the central axis.

5. The system of claim 1, wherein first and second volumes are fluidly coupled together via an opening in the tank, a fluid conduit, or a combination thereof.

6. The system of claim 1, wherein the housing of the compensation system is directly coupled to the tank.

7. The system of claim 1, wherein the housing of the compensation system is offset away from the tank, wherein the first and second volumes are fluidly coupled with a fluid conduit.

8. The system of claim 7, wherein the compensation system comprises a bottom wall coupled to the housing over the second volume, wherein the fluid conduit extends between the bottom wall and an outer wall of the tank.

9. The system of claim 1, wherein the compensation system comprises a cover lid coupled to the housing over the fourth volume, wherein an opening or a fluid conduit is coupled to the cover lid and provides fluid communication with the surrounding seawater.

10. The system of claim 1, wherein an outer wall of the housing comprises a flexible portion configured to enable expansion or contraction of the third volume.

11. The system of claim 1, wherein the third volume is fluidly coupled to a fifth volume of a supplemental compensator.

12. The system of claim 11, wherein the supplemental compensator comprises a third bellows.

13. The system of claim 11, wherein the supplemental compensator is disposed inside of the tank.

14. The system of claim 11, wherein the supplemental compensator is disposed outside of the tank.

15. A subsea system, comprising:
a tank configured to house a component surrounded by a first volume of a first fluid; and
a compensation system coupled to the tank, wherein the compensation system comprises:
a housing disposed about a central axis;
first and second bellows disposed about the central axis inside of the housing; and
a compensator cover coupled to the first and second bellows at an axial position between first and second axial ends of the housing, wherein the first bellows and the compensator cover defines a second volume between the compensator cover and the first axial end, the housing and the first and second bellows define a third volume, and the second bellows and the compensator cover define a fourth volume, wherein the first and second volumes are configured to balance pressures relative to one another, and wherein the fourth volume is configured to balance pressures between a surrounding seawater and the second volume, wherein the first and second bellows define a double barrier separated by the third volume.

16. The system of claim 15, wherein the housing of the compensation system is directly coupled to the tank.

17. The system of claim 15, wherein the housing of the compensation system is offset away from the tank, wherein the first and second volumes are fluidly coupled with a fluid conduit.

18. A method, comprising:
housing a transformer surrounded by a first volume of a first fluid in a tank; and
pressure balancing the tank with a compensation system coupled to the tank, wherein the compensation system comprises:
a housing disposed about a central axis;
first and second flexible walls disposed about the central axis inside of the housing; and
a compensator cover coupled to the first and second flexible walls at an axial position between first and second axial ends of the housing, wherein the first flexible wall and the compensator cover defines a second volume between the compensator cover and the first axial end, the housing and the first and second flexible walls define a third volume, and the second flexible wall and the compensator cover define a fourth volume, wherein the pressure balancing comprises:
balancing pressures between the first and second volumes;
balancing pressures between a surrounding seawater and the second volume via the fourth volume; and
defining a double barrier separated by the third volume via the first and second flexible walls.

19. The method of claim 18, comprising adjusting the third volume with an outer wall of the housing comprising a flexible portion configured to enable expansion or contraction of the third volume.

20. The method of claim 18, comprising adjusting the third volume with a supplemental compensator comprising a third bellows separate from the housing.
